(19) United States
(12) Patent Application Publication
(10) Pub. No.: US 2022/0290025 A1
(43) Pub. Date: Sep. 15, 2022

(54) RESIN COMPOSITION, HEAT STORAGE MATERIAL, AND ARTICLE

(71) Applicant: Showa Denko Materials Co., Ltd., Chiyoda-ku, Tokyo (JP)

(72) Inventors: Naoki FURUKAWA, Chiyoda-ku, Tokyo (JP); Tsuyoshi MORIMOTO, Chiyoda-ku, Tokyo (JP); Hiroshi YOKOTA, Chiyoda-ku, Tokyo (JP); Atsuko SANO, Chiyoda-ku, Tokyo (JP)

(21) Appl. No.: 17/633,211

(22) PCT Filed: Aug. 9, 2019
(86) PCT No.: PCT/JP2019/031733

§ 371 Date: Feb. 7, 2022

(51) Int. Cl. C09K 5/06; C08F 220/28; C08K 3/22

(52) U.S. Cl. CPC C09K 5/063; C08F 220/288; C08K 3/22; C08F 2800/20

(57) ABSTRACT

A resin composition contains: an acrylic resin polymerized from a monomer component containing a monomer represented by the following formula (1); and a heat storage inorganic material,

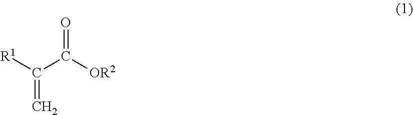

wherein R¹ represents a hydrogen atom or a methyl group, and R² represents a monovalent group having a polyoxyalkylene chain.

### TECHNICAL FIELD

The present invention relates to a resin composition, a heat storage material, and an article.

### BACKGROUND ART

A heat storage material is a material from which stored energy can be extracted as heat as necessary. This heat storage material is used for applications, such as for example, electronic components such as in an air conditioning device, a floor heating device, a refrigerator, and an IC chip, automobile components such as in an automobile interior and exterior materials, and a canister, and an insulation container.

As a heat storage method, latent heat storage using a phase change in a substance is widely used in consideration of the magnitude of the amount of heat. Water-ice is well known as a latent heat storage substance. Water-ice is a substance having a large amount of heat, but its phase change temperature is limited to 0° C. in the atmosphere, and thus its application range is also limited. Therefore, paraffin is used as a latent heat storage substance having a phase change temperature of higher than 0° C. and 100° C. or lower. However, paraffin becomes a liquid when its phase changes due to heating, and has a risk of ignition and combustion. Therefore, in order to use paraffin as a heat storage material, it is necessary to store the paraffin in a closed container such as a bag, and to prevent the paraffin from leaking from the heat storage material, and thus its application fields are limited.

In this regard, as a method of improving a heat storage material containing paraffin, for example, Patent Literature 1 discloses a method using a gelling agent. The gel produced by this method can be maintained as a gel-like molded product even after the phase of paraffin has changed. However, in this method, when used as a heat storage material, liquid leakage, volatilization of the heat storage material, and the like may occur.

Furthermore, as another improving method, for example, Patent Literature 2 discloses a method using a hydrogenated conjugated diene copolymer. In this method, a form thereof can be maintained near a melting or solidification temperature of a hydrocarbon compound, but at a higher temperature, phase separation occurs due to low compatibility, and liquid leakage of the hydrocarbon compound occurs.

### CITATION LIST

### Patent Literature

Patent Literature 1: Japanese Unexamined Patent Publication No. 2000-109787

Patent Literature 2: Japanese Unexamined Patent Publication No. 2014-95023

### SUMMARY OF INVENTION

### Technical Problem

An object of an aspect of the present invention is to provide a resin composition that is suitably used for forming a heat storage material.

### Solution to Problem

An aspect of the present invention is a resin composition containing: an acrylic resin polymerized from a monomer component containing a monomer (monomer A) represented by the following formula (1); and a heat storage inorganic material,

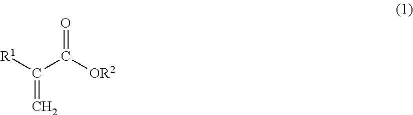

wherein R¹ represents a hydrogen atom or a methyl group, and R² represents a monovalent group having a polyoxyalkylene chain.

Another aspect of the present invention is a resin composition containing: an acrylic resin containing a structural unit (structural unit A) represented by the following formula (2); and a heat storage inorganic material,

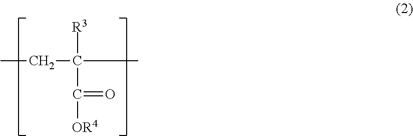

wherein R³ represents a hydrogen atom or a methyl group, and R⁴ represents a monovalent group having a polyoxyalkylene chain.

These resin compositions contain the heat storage inorganic material, and thus a heat storage material having excellent heat storage properties attributable to the magnitude of the heat storage amount of the heat storage inorganic material is easily formed, for example, as compared to a resin composition only containing a heat storage organic material. In addition, these resin compositions contain not only the heat storage inorganic material but also the specific acrylic resin having excellent heat storage properties (the acrylic resin that has the specific structural unit having the polyoxyalkylene chain). Therefore, while a decrease in the heat storage amount of the entire resin composition (heat storage material) is suppressed, the heat storage inorganic material can be held by the acrylic resin. Thus, for example, in the formed heat storage material, both of heat storage properties and flexibility can be achieved. Further, this acrylic resin can also be cured as necessary, and thus liquid leakage and volatilization of the components constituting the heat storage material can be suppressed.

The monomer component may further contain a monomer B copolymerizable with the monomer A and having a reactive group. The acrylic resin may further contain a structural unit B having a reactive group in addition to the structural unit A. The reactive group may be at least one group selected from the group consisting of a carboxyl group, a hydroxyl group, an isocyanate group, an amino group, and an epoxy group.

The resin composition may further contain a curing agent capable of reacting with the reactive group. The curing agent may be at least one curing agent selected from the group consisting of an isocyanate-based curing agent, a phenol-based curing agent, an amine-based curing agent, an imidazole-based curing agent, and an acid anhydride-based curing agent.

The heat storage inorganic material may contain vanadium dioxide.

The resin composition may further contain a capsule encapsulating a heat storage organic material.

A content of the heat storage inorganic material may be 50% by mass or more based on a total amount of the resin composition.

The resin composition may be used for forming a heat storage material.

Another aspect of the present invention is a heat storage material containing a cured product of the above-described resin composition. Another aspect of the present invention is an article containing: a heat source; and a cured product of the above-described resin composition, the cured product being provided to be in thermal contact with the heat source.

### Advantageous Effects of Invention

According to an aspect of the present invention, it is possible to provide a resin composition that is suitably used for forming a heat storage material.

### BRIEF DESCRIPTION OF DRAWINGS

FIG. 1 is a schematic cross-sectional view illustrating an embodiment of a heat storage material.

FIG. 2 is a schematic cross-sectional view illustrating an embodiment of an article and a production method therefor.

FIG. 3 is a schematic cross-sectional view illustrating another embodiment of the article.

FIG. 4 is a schematic cross-sectional view illustrating another embodiment of the method for producing an article.

### DESCRIPTION OF EMBODIMENTS

Hereinafter, embodiments of the present invention will be specifically described with reference to the drawings. Note that, the present invention is not limited to the following embodiments.

In the present specification, “(meth)acrylate” means “acrylate” and its corresponding “methacrylate”, and “(meth)acryloyl” means “acryloyl” and its corresponding “methacryloyl”.

A weight average molecular weight (Mw) and a number average molecular weight (Mn) in the present specification mean values that are measured using gel permeation chromatography (GPC) under the following conditions and determined using polystyrene as a standard substance.

Measurement instrument: HLC-8320GPC (product name, manufactured by Tosoh Corporation)

Analysis column: TSKgel SuperMultipore HZ-H (there columns connected) (product name, manufactured by Tosoh Corporation)

Guard column: TSKguardcolumn SuperMP (HZ)-H (product name, manufactured by Tosoh Corporation)

Eluent: THF

Measurement temperature: 25° C.

In the present specification, “heat resistance is favorable” means that a 1% weight loss temperature in TG-DTA measurement is 200° C. or higher.

A resin composition according to an embodiment contains an acrylic resin and a heat storage inorganic material. The acrylic resin is a polymer polymerized from a monomer component that contains a monomer A.

The monomer A is represented by the following formula (1):

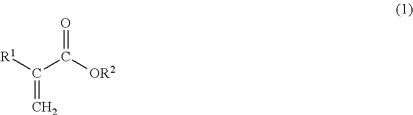

wherein R¹ represents a hydrogen atom or a methyl group, and R² represents a monovalent group having a polyoxyalkylene chain.

The group having the polyoxyalkylene chain represented as R² may be a group represented by the following formula (3):

*—(R^{b}O)ₙ—R^{a} (3)

wherein R^{a} represents a hydrogen atom or an alkyl group having 1 to 18 carbon atoms, R^{b} represents an alkylene group, n represents an integer of 2 or more, and * represents a bonding site.

The alkyl group represented as R^{a} may be linear or branched. The number of carbon atoms of the alkyl group represented as R^{a} is preferably 1 to 15, more preferably 1 to 10, and further preferably 1 to 5. R^{a} is particularly preferably a hydrogen atom or a methyl group.

The alkylene group represented as R^{b} may be linear or branched. R^{b} may be, for example, an alkylene group having 2 to 4 carbon atoms. A plurality of R^{b}s that are present in the polyoxyalkylene chain may be the same as or different from each other. The polyoxyalkylene chain preferably has one or two or more kinds selected from the group consisting of an oxyethylene group, an oxypropylene group, and an oxybutylene group, more preferably has one or two or more kinds selected from the group consisting of an oxyethylene group and an oxypropylene group, and further preferably has only an oxyethylene group.

n may be appropriately selected according to the melting point of a target heat storage material, and may be an integer of 2 or more, 4 or more, 6 or more, or 8 or more, and may be an integer of 230 or less, 220 or less, 210 or less, or 200 or less, for example.

In other words, the monomer A may be a (meth)acrylate that has a monovalent group having a polyoxyalkylene chain represented by formula (3) at the end of an ester group. Examples of the monomer A include polyethylene glycol (meth)acrylate, methoxypolyethylene glycol (meth)acrylate, polypropylene glycol (meth)acrylate, methoxypolypropylene glycol (meth)acrylate, polybutylene glycol (meth)acrylate, and methoxypolybutylene glycol (meth)acrylate. In these monomers A, n in the formula (3) may be, for example, an integer of 2 to 90.

Commercially available products can be used as the monomer A represented by the formula (1). The commercially available products used as the monomer A may be PP-500, PP-800, PP-1000, AP-400, AP-550, AP-800, 700PEP-350B, 10PEP-550B, 55PET-400, 30PET-800, 55PET-800, 30PPT-800, 50PPT-800, 70PPT-800, PME-100, PME-200, PME-400, PME-1000, PME-4000, AME-400, 50POEP-800B, and 50AOEP-800B manufactured by NOF CORPORATION; LIGHT ESTER 130MA and 041MA, LIGHT ACRYLATE 130A, and LIGHT ACRYLATE NP-4EA manufactured by Kyoeisha Chemical Co., Ltd.; MA-30, MA-50, MA-100, MA-150, RMA-1120, RMA-564, RMA-568, RMA-506, MPG130-MA, Antox MS-60, MPG-130MA, RMA-150M, RMA-300M, RMA-450M, RA-1020, RA-1120, and RA-1820 manufactured by NIPPON NYUKAZAI CO., LTD.; methoxypolyethylene glycol acrylate AM-30G, AM-90G, AM-130G, AM-230G, and AM-450G, and methoxypolypropylene glycol acrylate AM-30PG, M-40G, M-90G, M-130G, and M-230G manufactured by SHIN-NAKAMURA CHEMICAL Co., Ltd.; ELEMINOL RS-30 manufactured by Sanyo Chemical Industries, Ltd.; Bismer MPE400A and Bismer MPE550A manufactured by OSAKA ORGANIC CHEMICAL INDUSTRY LTD.; and the like.

The content of the monomer A may be 20 parts by mass or more, 25 parts by mass or more, or 30 parts by mass or more with respect to 100 parts by mass of the monomer component, the content is preferably 60 parts by mass or more, more preferably 80 parts by mass or more, further preferably 85 parts by mass or more, and particularly preferably 90 parts by mass or more, from the viewpoint of obtaining a further excellent heat storage amount when a heat storage material is formed, and the content may be, for example, 98 parts by mass or less.

The monomer component may further contain a monomer B (reactive monomer) that is copolymerizable with the monomer A and has a reactive group, in addition to the monomer A. The monomer B has a group having an ethylenically unsaturated bond (ethylenically unsaturated group) so that it is copolymerizable with the monomer A. Examples of the ethylenically unsaturated group include a (meth)acryloyl group, a vinyl group, and an allyl group. The monomer B is preferably a monomer having a reactive group and a (meth)acryloyl group (a (meth)acrylic monomer having a reactive group). The monomer B is used alone or two or more kinds thereof are used in combination.

The reactive group in the monomer B may be, for example, a group that can react with a curing agent to be described below, and may be a group that can react with water (for example, moisture contained in air). The reactive group is, for example, at least one group selected from the group consisting of a carboxyl group, a hydroxyl group, an isocyanate group, an amino group, and an epoxy group. That is, the monomer B is, for example, a carboxyl group-containing monomer, a hydroxyl group-containing monomer, an isocyanate group-containing monomer, an amino group-containing monomer, or an epoxy group-containing monomer. In an embodiment, the reactive group may be at least one group selected from the group consisting of a hydroxyl group, an isocyanate group, an amino group, and an epoxy group, and may be at least one group selected from the group consisting of a hydroxyl group, an isocyanate group, and an epoxy group.

Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid.

Examples of the hydroxyl group-containing monomer include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; and hydroxyalkyl cycloalkane (meth)acrylates such as (4-hydroxymethylcyclohexyl)methyl (meth)acrylate. The hydroxyl group-containing monomer may be hydroxyethyl (meth)acrylamide, allyl alcohol, 2-hydroxyethyl vinyl ether, 4-hydroxybutyl vinyl ether, diethylene glycol monovinyl ether, or the like.

Examples of the isocyanate group-containing monomer include 2-methacryloyloxyethyl isocyanate and 2-acryloyloxyethyl isocyanate.

The isocyanate group in the isocyanate group-containing monomer may be blocked (protected) with a blocking agent (protective group) capable of being removed by heat. That is, the isocyanate group-containing monomer may be a monomer having a blocked isocyanate group represented by the following formula (4):

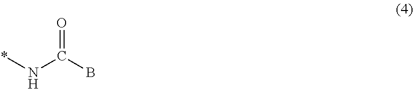

wherein B represents a protective group, and * represents a bonding site.

The protective group in the blocked isocyanate group may be a protective group that can be removed (deprotected) by heating (for example, heating at 80° C. to 160° C.). In the blocked isocyanate group, a substitution reaction between the blocking agent (protective group) and the curing agent to be described below may occur under deprotection conditions (for example, a heating condition of 80° C. to 160° C.). Alternatively, in the blocked isocyanate group, an isocyanate group may be generated due to deprotection, and the isocyanate group can also react with the curing agent to be described below.

Examples of the blocking agent in the blocked isocyanate group include oxime compounds such as formaldoxime, acetaldoxime, acetoxime, methylethylketoxime, and cyclohexanone oxime; pyrazole compounds such as pyrazole, 3-methylpyrayole, and 3,5-dimethylpyrayole; lactam compounds such as ε-caprolactam, δ-valerolactam, γ-butyrolactam, and β-propiolactam; mercaptan compounds such as thiophenol, methylthiophenol, and ethylthiophenol; acid amide compounds such as acetamide and benzamide; and imide compounds such as succinimide and maleic acid imide.

Examples of the monomer having a blocked isocyanate group include 2-[(3,5-dimethylpyrazolyl)carbonylamino]ethyl methacrylate and 2-(0-[1′-methylpropylideneamino]carboxyamino) methacrylate.

Examples of the amino group-containing monomer include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of the epoxy group-containing monomer include glycidyl (meth)acrylate, α-ethyl glycidyl (meth)acrylate, α-n-propyl glycidyl (meth)acrylate, α-n-butyl glycidyl (meth)acrylate, 3,4-epoxybutyl (meth)acrylate, 4,5-epoxypentyl (meth)acrylate, 6,7-epoxyheptyl (meth)acrylate, 6,7-epoxyheptyl α-ethyl (meth)acrylate, 3-methyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and β-methylglycidyl α-ethyl (meth)acrylate.

The content of the monomer B may be 2 parts by mass or more, 3 parts by mass or more, or 5 parts by mass or more, may be 25 parts by mass or less, and is preferably 20 parts by mass or less, more preferably 15 parts by mass or less, further preferably 13 parts by mass or less, and particularly preferably 10 parts by mass or less, with respect to 100 parts by mass of the monomer component, from the viewpoint of a further excellent heat storage amount of the heat storage material.

The monomer component may further contain other monomers as necessary in addition to the monomer A and the monomer B. The other monomers are monomers that are copolymerizable with the monomer A and the monomer B (provided that, the monomers are other than the monomer A and the monomer B). The other monomers have, for example, a group having an ethylenically unsaturated bond (ethylenically unsaturated group) so that they are copolymerizable with the monomer A and the monomer B. The ethylenically unsaturated group may be, for example, a (meth)acryloyl group, a vinyl group, an allyl group, or the like, and is preferably a (meth)acryloyl group.

The other monomers may contain one ethylenically unsaturated group or two or more ethylenically unsaturated groups. In a case where the other monomers contain two or more ethylenically unsaturated groups, a crosslink derived from the other monomer can be formed in an acrylic resin to be obtained.

The other monomers containing one ethylenically unsaturated group may be, for example, at least one monomer (monomer C) selected from the group consisting of an alkyl (meth)acrylate having a linear or branched alkyl group having 1 to 30 carbon atoms at the end of an ester group and a cycloalkyl (meth)acrylate having a cyclic hydrocarbon group at the end of an ester group.

The alkyl (meth)acrylate having a linear or branched alkyl group having 1 to 30 carbon atoms at the end of an ester group may be, for example, an alkyl (meth)acrylate having a linear or branched alkyl group having 12 to 30 carbon atoms at the end of an ester group such as dodecyl (meth)acrylate (lauryl (meth)acrylate), tetradecyl (meth)acrylate, hexadecyl (meth)acrylate, octadecyl (meth)acrylate (stearyl (meth)acrylate), docosyl (meth)acrylate (behenyl (meth)acrylate), tetracosyl (meth)acrylate, hexacosyl (meth)acrylate, or octacosyl (meth)acrylate.

The alkyl (meth)acrylate having a linear or branched alkyl group having 1 to 30 carbon atoms at the end of an ester group may be an alkyl (meth)acrylate having an alkyl group having less than 12 (1 to 11 carbon atoms) at the end of an ester group such as methyl (meth)acrylate, ethyl (meth)acrylate, propyl (meth)acrylate, or butyl (meth)acrylate.

The cycloalkyl (meth)acrylate having a cyclic hydrocarbon group at the end of an ester group may be isobornyl (meth)acrylate, dicyclopentanyl (meth)acrylate, or the like.

The other monomers containing two ethylenically unsaturated groups may be, for example, a monomer (monomer D) represented by the following formula (5):

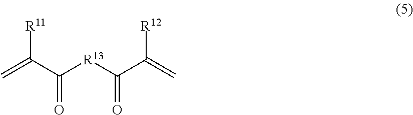

wherein R¹¹ and R¹² each independently represent a hydrogen atom or a methyl group, and R¹³ represents a divalent group having a polyoxyalkylene chain.

In an embodiment, one of R¹¹ and R¹² may be a hydrogen atom and the other thereof may be a methyl group, in another embodiment, both of R¹¹ and R¹² may be a hydrogen atom, and in still another embodiment, both of R¹¹ and R¹² may be a methyl group.

The polyoxyalkylene chain is represented, for example, by the following formula (6):

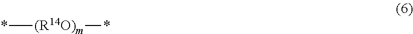

wherein R¹⁴ represents an alkylene group, in represents an integer of 2 or more, and * represents a bonding site.

The alkylene group represented as R¹⁴ may be linear or branched. R¹⁴ may be, for example, an alkylene group having 2 to 4 carbon atoms. A plurality of R^{m}s that are present in the polyoxyalkylene chain may be the same as or different from each other. A plurality of R^{m}s that are present in the polyoxyalkylene chain are one or two or more kinds selected from the group consisting of an ethylene group, a propylene group, and a butylene group and more preferably one or two or more kinds selected from the group consisting of an ethylene group and a propylene group, and further preferably, all of the plurality of R^{m}s are an ethylene group.

m may be an integer of 10 or more or 20 or more and may be an integer of 300 or less, 250 or less, or 200 or less, for example.

R¹³ may be a divalent group further having another organic group in addition to the polyoxyalkylene chain. The other organic group may be a chain-like group other than the polyoxyalkylene chain, and may be, for example, a methylene chain (a chain containing —CH₂— as a structural unit), a polyester chain (a chain containing —COO— as a structural unit), a polyurethane chain (a chain containing —OCON— as a structural unit), or the like.

The monomer D is preferably a monomer represented by the following formula (7):

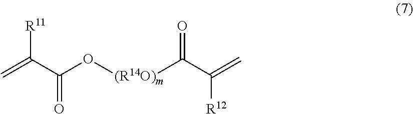

wherein R¹¹ and R¹² have the same definitions as R¹¹ and R¹² in the formula (5), respectively, and R¹⁴ and in have the same definitions as R¹⁴ and m in the formula (6).

The acrylic resin is obtained by polymerizing the monomer component containing the monomer A and the additional monomer(s) used as necessary. The polymerization method can be appropriately selected from various known polymerization methods such as radical polymerizations, and may be, for example, a suspension polymerization method, a solution polymerization method, a bulk polymerization method, or the like. As the polymerization method, in a case where the weight average molecular weight of the acrylic resin is set to be large (for example, 200000 or more), a suspension polymerization method is preferably used, and in a case where the weight average molecular weight of the acrylic resin is set to be small (for example, 150000 or less), a solution polymerization method is preferably used.

In the case of using a suspension polymerization method, monomer components as a raw material, a polymerization initiator, and a chain transfer agent, water and a suspension agent which are added as necessary are mixed to prepare a dispersion liquid.

Examples of the suspension agent include a water-soluble polymer such as polyvinyl alcohol, methyl cellulose, polyacrylamide, and a poorly soluble inorganic substance such as calcium phosphate and magnesium pyrophosphate. Among these, a water-soluble polymer such as polyvinyl alcohol is preferably used.

The blending amount of the suspension agent is preferably 0.005 to 1 part by mass, more preferably 0.007 to 0.08 parts by mass, and further preferably 0.01 to 0.07 parts by mass, with respect to the total amount of 100 parts by mass of the monomer components as a raw material. In the case of using a suspension polymerization method, a molecular weight adjusting agent such as a mercaptan-based compound, thioglycol, carbon tetrachloride, and α-methylstyrene dimer may be additionally added as necessary. The polymerization temperature is preferably 0° C. to 200° C., more preferably 20° C. to 150° C., and further preferably 40° C. to 120° C.

In the case of using a solution polymerization method, examples of solvents used include aromatic solvents such as toluene and xylene, ketone-based solvents such as methyl ethyl ketone and methyl isobutyl ketone, ester-based solvents such as ethyl acetate and butyl acetate, chlorine-based solvents such as carbon tetrachloride, and alcoholic solvents such as 2-propanol and 2-butanol. The concentration of the solid content in the solution when solution polymerization starts is preferably 40 to 70% by mass and more preferably 50 to 60% by mass from the viewpoint of polymerizability of an acrylic resin to be obtained, and may be 20 to 70% by mass, 25 to 65% by mass, or 40 to 60% by mass. The polymerization temperature is preferably 0° C. to 200° C. and more preferably 40° C. to 120° C., and may be 70° C. to 90° C.

In each polymerization method, a polymerization initiator may be used. The polymerization initiator may be, for example, a radical polymerization initiator. Examples of the radical polymerization initiator include organic peroxides such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane, and t-butyl peroxyisopropyl carbonate, and azo compounds such as azobisisobutyronitrile, azobis-4-methoxy-2,4-dimethylvaleronitrile, azobiscyclohexanone-1-carbonitrile, and azodibenzoyl.

The blending amount of the polymerization initiator is preferably 0.01 parts by mass or more, more preferably 0.05 parts by mass or more, and further preferably 0.1 parts by mass or more, with respect to the total amount of 100 parts by mass of the monomer components, from the viewpoint of sufficiently polymerizing monomers. The blending amount of the polymerization initiator is preferably 10 parts by mass or less, more preferably 5 parts by mass or less, and further preferably 3 parts by mass or less, with respect to the total amount of 100 parts by mass of the monomer components, from the viewpoint of setting the molecular weight of the acrylic resin to be within a suitable range, suppressing the amount of decomposition products, and obtaining a suitable adhesive strength when used as a heat storage material.

The acrylic resin obtained as described above has a structural unit derived from the monomer A. That is, the resin composition according to an embodiment contains an acrylic resin containing a structural unit A (a structural unit derived from the monomer A).

The structural unit A is represented by the following formula (2):

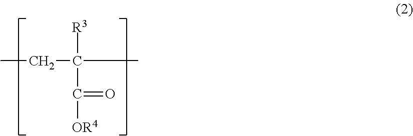

wherein R³ represents a hydrogen atom or a methyl group, and R⁴ represents a monovalent group having a polyoxyalkylene chain.

The monovalent group having a polyoxyalkylene chain represented as R⁴ may be the same group as the monovalent group having a polyoxyalkylene chain represented as IV mentioned above.

The content of the structural unit A may be 20 parts by mass or more, 25 parts by mass or more, or 30 parts by mass or more, with respect to 100 parts by mass of all structural units constituting the acrylic resin, and is preferably 60 parts by mass or more, more preferably 80 parts by mass or more, further preferably 85 parts by mass or more, and particularly preferably 90 parts by mass or more, from the viewpoint of obtaining a further excellent heat storage amount of the heat storage material, and may be, for example, 98 parts by mass or less.

The acrylic resin may further contain a structural unit B (a structural unit derived from the monomer B) having a reactive group in addition to the structural unit A. The reactive group may be, for example, a group that can react with a curing agent to be described below, and may be a group that can react with water (for example, moisture contained in air). The reactive group is, for example, at least one group selected from the group consisting of a carboxyl group, a hydroxyl group, an isocyanate group, an amino group, and an epoxy group. The structural unit B is, for example, a structural unit derived from the carboxyl group-containing monomer, the hydroxyl group-containing monomer, the isocyanate group-containing monomer, the amino group-containing monomer, or the epoxy group-containing monomer which is mentioned above. The acrylic resin may further contain one or two or more kinds of these structural units B.

The structural unit B is preferably a structural unit represented by the following formula (8):

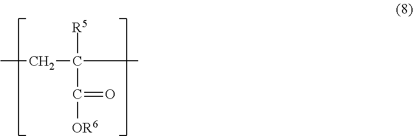

wherein R⁵ represents a hydrogen atom or a methyl group, and R⁶ represents a hydrogen atom or a monovalent organic group having a reactive group. In a case where R⁶ is a hydrogen atom, a —COOH group containing this R⁶ functions as a reactive group. The reactive group in the organic group represented as R⁶ may be the same as the reactive group in the monomer B mentioned above.

The content of the structural unit B may be 2 parts by mass or more, 3 parts by mass or more, or 5 parts by mass or more, may be 25 parts by mass or less, and is preferably 20 parts by mass or less, more preferably 15 parts by mass or less, further preferably 13 parts by mass or less, and particularly preferably 10 parts by mass or less, with respect to 100 parts by mass of all structural units constituting the acrylic resin, from the viewpoint of obtaining a further excellent heat storage amount when a heat storage material is formed.

The acrylic resin may further contain other structural units as necessary in addition to the structural unit A and the structural unit B. The other structural units may be structural units derived from the other monomers (the monomer C, the monomer D, and the like) mentioned above.

The acrylic resin may be any of a random copolymer, a block copolymer, and a graft copolymer.

In an embodiment, the weight average molecular weight of the acrylic resin is preferably 150000 or more, more preferably 200000 or more or 250000 or more, and further preferably 300000 or more, from the viewpoint of obtaining an excellent strength for the heat storage material. The weight average molecular weight of the acrylic resin is preferably 2000000 or less, more preferably 1500000 or less, and further preferably 1000000 or less, from the viewpoint of ease of handling of the resin composition.

In another embodiment, the weight average molecular weight of the acrylic resin is preferably 100000 or less, more preferably 70000 or less, and further preferably 40000 or less, from the viewpoint of reducing the viscosity of the resin composition. In this case, the weight average molecular weight of the acrylic resin may be, for example, 5000 or more.

The content of the acrylic resin may be 5% by mass or more, 10% by mass or more, or 20% by mass or more, and may be 50% by mass or less, 40% by mass or less, or 30% by mass or less, based on the total amount of the resin composition.

The resin composition further contains a heat storage inorganic material from the viewpoint of further increasing a heat storage amount. The heat storage inorganic material is a material that is configured by an inorganic compound having heat storage properties. The heat storage inorganic material may be, for example, an inorganic material having heat storage properties attributable to solid-liquid phase transition, solid-solid phase transition, or electronic phase transition.

Examples of the inorganic material having heat storage properties attributable to electronic phase transition include VO₂, LiMn₂O₄, LiVS₂, LiVO₂, NaNiO₂, XBaFe₂O₅, and XBaCo₂O_{5.5} (X represents a rare-earth element such as Y, Sin, Pr, Eu, Gd, Dy, Ho, or Tb).

Examples of the inorganic material having heat storage properties attributable to solid-solid phase transition include materials that undergo martensitic transformation (shape-memory alloys such as NiTi, CuZnAl, and CuAlNi), thermochromic materials (such as N,N-diethylethylenediamine copper complex), soft-viscous crystals (such as trimethylol ethane, pentaerythritol, and neopentyl glycol), magnetic phase transition substances (such as Mn—Zn ferrite and NiFe alloys), and paraelectric-ferroelectric transition substances (such as BaTiO₃).

Examples of the inorganic material having heat storage properties attributable to solid-liquid phase transition include inorganic hydrates such as calcium chloride hydrate, sodium acetate hydrate, potassium acetate hydrate, sodium hydroxide hydrate, potassium hydroxide hydrate, strontium hydroxide hydrate, barium hydroxide hydrate, sodium chloride hydrate, magnesium chloride hydrate, zinc chloride hydrate, lithium nitrate hydrate, magnesium nitrate hydrate, calcium nitrate hydrate, aluminum nitrate hydrate, cadmium nitrate, iron nitrate hydrate, zinc nitrate hydrate, manganese nitrate hydrate, lithium sulfate hydrate, sodium sulfate hydrate, sodium thiosulfate hydrate, magnesium sulfate hydrate, calcium sulfate hydrate, aluminum potassium sulfate hydrate, ammonium aluminum sulfate hydrate, sodium thiosulfate hydrate, potassium phosphate hydrate, sodium phosphate hydrate, potassium hydrogenphosphate hydrate, sodium hydrogenphosphate hydrate, sodium borate hydrate, calcium bromide hydrate, potassium fluoride hydrate, and sodium carbonate hydrate.

These heat storage inorganic materials are used alone or two or more kinds thereof are used in combination. The heat storage inorganic material is preferably an inorganic material having heat storage properties attributable to electronic phase transition, and is more preferably VO₂ (vanadium dioxide). A part or the whole of the heat storage inorganic material may be contained in the resin composition in a state of a capsule encapsulated in an outer shell (shell). The material forming the outer shell (shell) may be the same as a material forming an outer shell (shell) in a heat storage capsule to be described below.

The content of the heat storage inorganic material, based on the total amount of the resin composition, is preferably 50% by mass or more, more preferably 60% by mass or more, further preferably 70% by mass or more, and particularly preferably 80% by mass or more, from the viewpoint of further improving the heat storage amount of a heat storage material to be formed, and may be, for example, 95% by mass or less.

The resin composition may further contain a heat storage organic material from the viewpoint of further enhancing a heat storage effect. The heat storage organic material may be an organic material that can store heat, and may be, for example, a component that has heat storage properties attributable to phase transition (provided that, excluding the aforementioned acrylic resin). As the heat storage organic material, a component having a phase transition temperature that matches a target temperature is appropriately selected according to the purpose of use. The heat storage organic material has, for example, a solid-liquid phase transition point (melting point) of −30° C. to 120° C. from the viewpoint of obtaining a heat storage effect in a practical range.

The heat storage organic material may be, for example, a saturated hydrocarbon compound (paraffin-based hydrocarbon compound), natural wax, petroleum wax, polyalkylene glycol, sugar alcohol, or the like. The heat storage organic material is preferably a saturated hydrocarbon compound (paraffin-based hydrocarbon compound) from the viewpoint that the saturated hydrocarbon compound is inexpensive and has low toxicity and it is possible to easily select one having a desired phase transition temperature.

The saturated hydrocarbon compound may be, specifically, n-decane (C10 (number of carbon atoms, the same applies hereinafter), −29° C. (transition point (melting point), the same applies hereinafter)), n-undecane (C11, −25° C.), n-dodecane (C12, −9° C.), n-tridecane (C13, −5° C.), n-tetradecane (C14, 6° C.), n-pentadecane (C15, 9° C.), n-hexadecane (C16, 18° C.), n-heptadecane (C17, 21° C.), n-octadecane (C18, 28° C.), n-nonadecane (C19, 32° C.), n-eicosane (C20, 37° C.), n-heneicosane (C21, 41° C.), n-docosane (C22, 46° C.), n-tricosane (C23, 47° C.), n-tetracosane (C24, 50° C.), n-pentacosane (C25, 54° C.), n-hexacosane (C26, 56° C.), n-heptacosane (C27, 60° C.), n-octacosane (C28, 65° C.), n-nonacosane (C29, 66° C.), n-triacontane (C30, 67° C.), n-tetracontane (C40, 81° C.), n-pentacontane (C50, 91° C.), n-hexacontane (C60, 98° C.), n-hectane (C100, 115° C.), or the like.

The saturated hydrocarbon compound may be a linear saturated hydrocarbon compound as those described above, and may be a branched saturated hydrocarbon compound having the same number of carbon atoms as these linear saturated hydrocarbon compounds. The saturated hydrocarbon compound may be of one type or of two or more types.

The polyalkylene glycol may be, for example, polyethylene glycol, polypropylene glycol, polybutylene glycol, or the like, and is preferably polyethylene glycol. The weight average molecular weight (Mw) of the polyalkylene glycol may be 800 or more, 900 or more, or 1000 or more, and may be 2000 or less, 1900 or less, or 1800 or less.

The content of the heat storage organic material may be 1% by mass or more, 2% by mass or more, or 3% by mass or more, and may be 20% by mass or less, 10% by mass or less, or 5% by mass or less, based on the total amount of the resin composition.

The heat storage capsule has a heat storage organic material and an outer shell (shell) encapsulating the heat storage organic material. In an embodiment, the heat storage organic material may be contained in the resin composition in a state of being encapsulated in a capsule. That is, in an embodiment, the resin composition may further contain a capsule encapsulating a heat storage organic material (hereinafter, also referred to as “heat storage capsule”). In another embodiment, the heat storage organic material may be contained in the resin composition in a state of being not contained in a capsule.

The heat storage capsule has a heat storage organic material and an outer shell (shell) encapsulating the heat storage organic material. The outer shell (shell) is preferably formed of a material having a heat resistance temperature sufficiently higher than the transition point (melting point) of the heat storage organic material. The material forming the outer shell has a heat resistance temperature that is, for example, 30° C. or higher, and preferably 50° C. or higher, with respect to the transition point (melting point) of the heat storage organic material. Note that, the heat resistance temperature is defined as a temperature at which a 1% weight loss occurs when the weight loss of the capsule is measured using a differential thermogravimetric simultaneous measurement device (for example, TG-DTA6300 (manufactured by Hitachi High-Tech Science Corporation)).

Regarding the material forming the outer shell, a material having a strength according to the application of the heat storage material formed of the resin composition is appropriately selected. The outer shell is preferably formed of a melamine resin, an acrylic resin, a urethane resin, silica, or the like. Examples of micro capsules having an outer shell made of a melamine resin include BA410xxP, 6C, BA410xxP, 18C, BA410xxP, 37C manufactured by Outlast Technology LLC, Thermo Memory FP-16, FP-25, FP-31, and FP-39 manufactured by Mitsubishi Paper Mills Limited, and Riken Resin PMCD-15SP, 255P, and 32SP manufactured by Mikiriken Industrial Co., Ltd. Examples of micro capsules having an outer shell made of an acrylic resin (polymethylmethacrylate resin) include Micronal DS5001X and 5040X manufactured by BASF. Examples of micro capsules having an outer shell made of silica include Riken Resin LA-15, LA-25, and LA-32 manufactured by Mikiriken Industrial Co., Ltd.

The content of the heat storage organic material in the heat storage capsule, based on the total amount of the heat storage capsule, is preferably 20% by mass or more and more preferably 60% by mass or more, from the viewpoint of further enhancing the heat storage effect, and is preferably 80% by mass or less from the viewpoint of suppressing breakage of the capsule due to change in the volume of the heat storage organic material.

The heat storage capsule may further contain graphite, a metal powder, an alcohol, or the like in the outer shell in order to adjust the thermal conductivity of the capsule, a specific gravity, or the like.

The particle size (average particle size) of the heat storage capsule is preferably 0.1 μm or more, more preferably 0.2 μm or more, and further preferably 0.5 μm or more, and is preferably 100 μm or less and more preferably 50 μm or less. The particle size (average particle size) of the heat storage capsule is measured using a laser diffraction particle size distribution measurement device (for example, SALD-2300 (manufactured by SHIMADZU CORPORATION)).

The heat storage capacity of the heat storage capsule (powder state) is preferably 150 J/g or more from the viewpoint that a heat storage material having a higher heat storage density can be obtained. The heat storage capacity is measured by differential scanning calorimetry (DSC).

Regarding a method of producing a heat storage capsule, an appropriate method may be selected from conventionally known production methods such as an interfacial polymerization method, an in-situ polymerization method, an in-liquid curing coating method, and a coacervate method, according to the heat storage organic material, the material of the outer shell, and the like.

The content of the heat storage capsule may be 1% by mass or more, 3% by mass or more, or 5% by mass or more, and may be 30% by mass or less, 20% by mass or less, or 10% by mass or less, based on the total amount of the resin composition.

When used for forming the heat storage material, the resin composition may further contain a curing agent from the viewpoint of suppressing liquid leakage and volatilization of the components constituting the heat storage material and improving heat resistance. The curing agent is a curing agent capable of reacting with the reactive group contained in the monomer B (structural unit B).

The curing agent may be a thermosetting agent that reacts with the reactive group contained in the monomer B (structural unit B). In a case where the curing agent is a thermosetting agent, the resin composition may be a resin composition that is cured by heating at preferably 105° C. or higher, more preferably 110° C. or higher, and further preferably 115° C. or higher, and may be, for example, a resin composition that is cured by heating at 200° C. or lower, 190° C. or lower, or 180° C. or lower. The heating time when the resin composition is heated may be appropriately selected according to the composition of the resin composition so that the resin composition is suitably cured.

Examples of the curing agent include an isocyanate-based curing agent, a phenol-based curing agent, an amine-based curing agent, an imidazole-based curing agent, an acid anhydride-based curing agent, and a carboxylic acid-based curing agent. These curing agents may be used alone or two or more kinds thereof may be used in combination according to the type of the reactive group contained in the monomer B (structural unit B).

Examples of the isocyanate-based curing agent include aromatic diisocyanates such as tolylene diisocyanate (2,4- or 2,6-tolylene diisocyanate, or mixtures thereof) (TDI), phenylene diisocyanate (m- or p-phenylene diisocyanate, or mixtures thereof), 4,4′-diphenyl diisocyanate, 1,5-naphthalene diisocyanate (NDI), diphenylmethane diisocyanate (4,4′-, 2,4′-, or 2,2′-diphenylmethane diisocyanate, or mixtures thereof) (MDI), 4,4′-toluidine diisocyanate (TODI), and 4,4′-diphenyl ether diisocyanate, xylylene diisocyanate (1,3- or 1,4-xylylene diisocyanate, or mixtures thereof) (XDI), tetramethyl xylylene diisocyanate (1,3- or 1,4-tetramethyl xylylene diisocyanate, or mixtures thereof) (TMXDI), and ω,ω′-diisocyanate-1,4-diethylbenzene. Examples of the isocyanate-based curing agent include aliphatic diisocyanates such as trimethylene diisocyanate, 1,2-propylene diisocyanate, butylene diisocyanate (tetramethylene diisocyanate, 1,2-butylene diisocyanate, 2,3-butylene diisocyanate, 1,3-butylene diisocyanate), 1,5-pentamethylene diisocyanate (PDI), 1,6-hexamethylene diisocyanate (HDI), 2,4,4- or 2,2,4-trimethylhexamethylene diisocyanate, and 2,6-diisocyanate methyl caprate, and alicyclic diisocyanates such as 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate) (IPDI), methylene bis(cyclohexyl isocyanate) (4,4′-, 2,4′- or 2,2′-methylene bis(cyclohexyl isocyanate), their trans, trans-form, trans, cis-form, cis, cis-form, or mixtures thereof) (H12MDI), methyl cyclohexane diisocyanate (methyl-2,4-cyclohexane diisocyanate, methyl-2,6-cyclohexane diisocyanate), norbornane diisocyanate (various isomers or mixtures thereof) (NBDI), and bis(isocyanatomethyl)cyclohexane (1,3- or 1,4-bis(isocyanatomethyl)cyclohexane or mixtures thereof) (H6XDI).

Examples of the phenol-based curing agent include phenol compounds having bisphenol A, bisphenol F, bisphenol S, 4,4′-biphenylphenol, tetramethyl bisphenol A, dimethyl bisphenol A, tetramethyl bisphenol F, dimethyl bisphenol F, tetramethyl bisphenol S, dimethyl bisphenol S, tetramethyl-4,4′-biphenol, dimethyl-4,4′-biphenylphenol, 1-(4-hydroxyphenyl)-2-[4-(1,1-bis-(4-hydroxyphenyl)ethyl)phenyl]propane, 2,2′-methylene-bis(4-methyl-6-tert-butylphenol), 4,4′-butylidene-bis(3-methyl-6-tert-butylphenol), trishydroxyphenylmethane, resorcinol, hydroquinone, pyrogallol, and diisopropylidene skeletons; phenol compounds having a fluorene skeleton such as 1,1-di-4-hydroxyphenylfluorene; cresol compounds; ethylphenol compounds; butylphenol compounds; octylphenol compounds; and various novolac resins such as novolac resins containing various phenols such as bisphenol A, bisphenol F, bisphenol S, and a naphthol compound as raw materials, a xylylene skeleton-containing phenol novolac resin, a dicyclopentadiene skeleton-containing phenol novolac resin, a biphenyl skeleton-containing phenol novolac resin, a fluorene skeleton-containing phenol novolac resin, and a furan skeleton-containing phenol novolac resin.

Examples of the amine-based curing agent include aromatic amines such as diaminodiphenylmethane, diaminodiphenyl sulfone, diaminodiphenyl ether, p-phenylenediamine, m-phenylenediamine, o-phenylenediamine, 1,5-diaminonaphthalene, and m-xylylenediamine, aliphatic amines such as ethylenediamine, diethylenediamine, hexamethylenediamine, isophorone diamine, bis(4-amino-3-methyldicyclohexyl)methane, and polyether diamine; and guanidine compounds such as dicyandiamide and 1-(o-tolyl)biguanide.

Examples of the imidazole-based curing agent include 2-methylimidazole, 2-ethyl-4-methylimidazole, 2-phenylimidazole, 2-undecylimidazole, 2-heptadecylimidazole, 2-phenyl-4-methylimidazole, 1-benzyl-2-phenylimidazole, 1-benzyl-2-methylimidazole, 1-cyanoethyl-2-methylimidazole, 1-cyanoethyl-2-phenylimidazole, 1-cyanoethyl-2-undecylimidazole, 2,3-dihydro-1H-pyrrolo-[1,2-a]benzimidazole, 2,4-diamino-6(2′-methylimidazole(1′))ethyl-s-triazine, 2,4-diamino-6(2′-undecylimidazole(1′))ethyl-s-triazine, 2,4-diamino-6 (2′-ethyl-4-methylimidazole(1′))ethyl-s-triazine, 2,4-diamino-6(2′-methylimidazole(1 ′))ethyl-s-triazine-isocyanuric acid adducts, 2-methylimidazole isocyanuric acid adducts, 2-phenylimidazole isocyanuric acid adducts, 2-phenyl-3,5-dihydroxymethylimidazole, 2-phenyl-4-methyl-5-hydroxymethylimidayole, and 1-cyanoethyl-2-phenyl-3,5-dicyanoethoxymethylimidazole.

Examples of the acid anhydride-based curing agent include aromatic carboxylic anhydrides such as phthalic anhydride, trimellitic anhydride, pyromellitic anhydride, benzophenone tetracarboxylic acid anhydride, ethylene glycol trimellitic anhydride, and biphenyl tetracarboxylic acid anhydride; anhydrides of aliphatic carboxylic acids such as nelaic acid, sebacic acid, and dodecanedioic acid; and alicyclic carboxylic acid anhydrides such as tetrahydrophthalic anhydride, hexahydrophthalic anhydride, nadic anhydride, Het anhydride, and himic anhydride.

Examples of the carboxylic acid-based curing agent include succinic acid, glutaric acid, adipic acid, sebacic acid, phthalic acid, isophthalic acid, and terephthalic acid.

The content of the curing agent may be 0.01% by mass or more, may be 10% by mass or less, 5% by mass or less, or 1% by mass or less, based on the total amount of the resin composition.

The resin composition may further contain a liquid medium. The liquid medium is not particularly limited as long as it is a solvent dissolving the components or a dispersion medium dispersing the components, and may be, for example, a liquid medium composed of an organic compound. Examples of the liquid medium include ethyl lactate, propylene glycol monomethyl ether acetate, ethyl acetate, butyl acetate, ethoxyethyl propionate, 3-methyl methoxy propionate, N,N-dimethylformamide, methyl ethyl ketone, cyclopentanone, cyclohexanone, propylene glycol monomethyl ether, toluene, and xylene. These liquid mediums may be used alone or two or more kinds thereof may be used in combination.

The content of the liquid medium may be 5% by mass or more or 10% by mass or more, and may be 80% by mass or less or 70% by mass or less, based on the total amount of the resin composition.

In a case where the resin composition contains a heat storage capsule, the resin composition preferably further contains a surface treatment agent from the viewpoint of improving adhesiveness at an interface between the acrylic resin and the heat storage capsule. The surface treatment agent may be, for example, a coupling agent.

Examples of the coupling agent include an aminosilane-based coupling agent, an epoxysilane-based coupling agent, a phenylsilane-based coupling agent, an alkylsilane-based coupling agent, an alkenylsilane-based coupling agent, an alkynylsilane-based coupling agent, a haloalkylsilane-based coupling agent, a siloxane-based coupling agent, a hydrosilane-based coupling agent, a silazane-based coupling agent, an alkoxysilane-based coupling agent, a chlorosilane-based coupling agent, a (meth)acrylsilane-based coupling agent, an isocyanurate silane-based coupling agent, a ureidosilane-based coupling agent, a mercaptosilane-based coupling agent, a sulfide silane-based coupling agent, and an isocyanate silane-based coupling agent. The coupling agent is preferably an aminosilane-based coupling agent from the viewpoint of the reactivity with a resin.

The content of the surface treatment agent may be 0.01% by mass or more, 0.02% by mass or more, or 0.05% by mass or more, may be 10% by mass or less, 5% by mass or less, or 2% by mass or less, based on the total amount of the resin composition.

The resin composition may further contain a curing accelerator from the viewpoint of accelerating the reaction between the reactive group, which may be contained in the acrylic resin, and the curing agent or the reaction between the reactive group and water. Examples of the curing accelerator include a tertiary amine-based curing accelerator, a quaternary ammonium salt-based curing accelerator, an organic phosphorus-based curing accelerator, and a tin catalyst. These curing accelerators may be used alone or two or more kinds thereof may be used in combination.

The content of the curing accelerator may be 0.005% by mass or more, 0.01% by mass or more, or 0.02% by mass or more, may be 1% by mass or less, 0.5% by mass or less, or 0.2% by mass or less, based on the total amount of the resin composition.

The resin composition may further contain an antioxidant from the viewpoint of improving the thermal reliability of a heat storage material to be formed. The antioxidant may be, for example, a phenol-based antioxidant, a benzophenone-based antioxidant, a benzoate-based antioxidant, a hindered amine-based antioxidant, a benzotriazole-based antioxidant, or the like.

The content of the antioxidant may be 0.1% by mass or more, 0.5% by mass or more, 0.8% by mass or more, or 1% by mass or more, may be 10% by mass or less, 5% by mass or less, or 3% by mass or less, based on the total amount of the resin composition.

The resin composition can further contain other additives as necessary. Examples of the other additives include a colorant, a filler, a crystal nucleating agent, a heat stabilizer, a thermal conductive material, a plasticizer, a foaming agent, a flame retardant, a damping agent, a dehydrating agent, and a flame retardant aid. The other additives are used alone or two or more kinds thereof are used in combination. The content (total content) of the other additives may be 0.1% by mass or more and may be 30% by mass or less, based on the total amount of the resin composition.

The resin composition may be a solid or liquid at 50° C., 80° C., or 90° C., and from the viewpoint of easily filling the resin composition into a member having a complicated shape and extending a heat storage material application range, the resin composition is preferably a liquid at 50° C., 80° C., or 90° C.

The viscosity of the resin composition at 80° C. is preferably 100 Pas or less, more preferably 50 Pa·s or less, and further preferably 40 Pas or less from the viewpoint of obtaining excellent flowability and handling properties, and may be 20 Pa·s or less or 10 Pa·s or less. From the same viewpoint, at the melting point of the acrylic resin+20° C., the resin composition has a viscosity that is preferably 100 Pa·s or less, more preferably 50 Pa·s or less, and further preferably 40 Pa·s or less. The viscosity of the resin composition at 80° C. or the viscosity of the resin composition at the melting point of the acrylic resin+20° C. may be, for example, 0.5 Pa·s or more.

The viscosity of the resin composition means a value measured based on JIS Z 8803, and specifically, a value measured by an E type viscometer (manufactured by TOKI SANGYO CO., LTD., PE-80L).

Note that, the viscometer can be calibrated based on JIS Z 8809-JS14000. Furthermore, the melting point of the acrylic resin means a value measured by the method described in Examples.

The resin composition described above is a curable composition that can be cured (for example, thermoset). The resin composition is suitably used as a heat storage material by curing the resin composition (suitable as a composition for a heat storage material). That is, the heat storage material according to an embodiment contains a cured product of the aforementioned resin composition.

This heat storage material contains a heat storage inorganic material, and thus has excellent heat storage properties attributable to the magnitude of the heat storage amount of the heat storage inorganic material, for example, as compared to a heat storage material only containing a heat storage organic material. In addition, this heat storage material contains not only the heat storage inorganic material but also a predetermined acrylic resin having excellent heat storage properties (an acrylic resin that has a specific structural unit having a polyoxyalkylene chain). Therefore, while a decrease in the heat storage amount of the entire heat storage material is suppressed, the heat storage inorganic material can be held by the acrylic resin. Thus, for example, in the heat storage material, both of heat storage properties and flexibility can be achieved. Further, this acrylic resin can also be cured as necessary, and thus liquid leakage and volatilization of the components constituting the heat storage material can be suppressed.

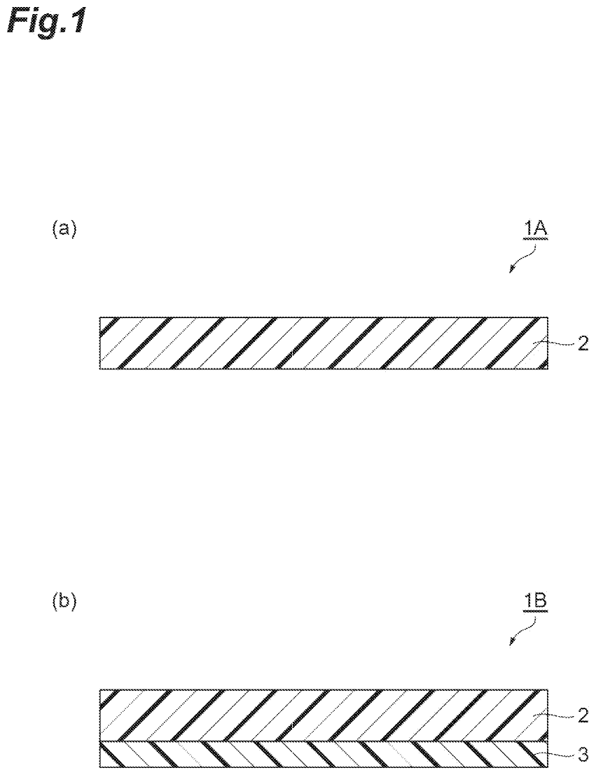

FIG. 1 is a schematic cross-sectional view illustrating an embodiment of a heat storage material. As illustrated in FIG. 1(a), a heat storage material 1A according to an embodiment is a sheet-shaped (or film-shaped) heat storage material containing a heat storage layer 2 that is a cured product of the aforementioned resin composition.

As illustrated in FIG. 1(b), a heat storage material 1B according to another embodiment is a sheet-shaped (or film-shaped) heat storage material containing the heat storage layer 2 that is a cured product of the aforementioned resin composition and an adhesive layer 3 provided on one surface of the heat storage layer 2. In this case, the heat storage material 1B can be more suitably attached to an object to which the heat storage material 1B is applied.

In the respective embodiments described above, the thickness of the heat storage layer 2 may be 0.01 mm or more, 0.05 mm or more, or 0.1 mm or more, and may be 20 mm or less, 10 mm or less, or 5 mm or less, for example.

In the respective embodiments described above, the heat storage layer 2 may be a cured product obtained by the resin composition being completely cured, and may be a cured product obtained by the resin composition being converted into a B stage (semi-cured). In the heat storage material 1A illustrated in FIG. 1(a), from the viewpoint that the heat storage material 1A can be suitably attached to an object to which the heat storage material 1A is applied, the heat storage layer 2 is preferably a cured product obtained by the resin composition being converted into a B stage (semi-cured).

The adhesive layer 3 may be configured by a known adhesive. The thickness of the adhesive layer 3 may be 0.001 mm or more, 0.003 mm or more, or 0.005 mm or more, and may be 0.03 mm or less, 0.02 mm or less, or 0.015 mm or less, for example.

The heat storage materials 1A and 1B (these are also collectively referred to as the heat storage material 1) can be utilized in various fields. The heat storage material 1 is used for, for example, air conditioning devices (for improving efficiency of air conditioning devices) in automobiles, buildings, public facilities, underground malls, and the like, pipes (for heat storage of pipes) in factories and the like, engines (for heat retention around the engine) in automobiles, electronic components (for preventing increasing of the temperature of electronic components), fibers for undergarments, and the like.

Next, an article containing the heat storage material 1 (a cured product of the resin composition) and a production method therefor will be described, for example, using an electronic component as an object in which the heat storage material 1 is provided.

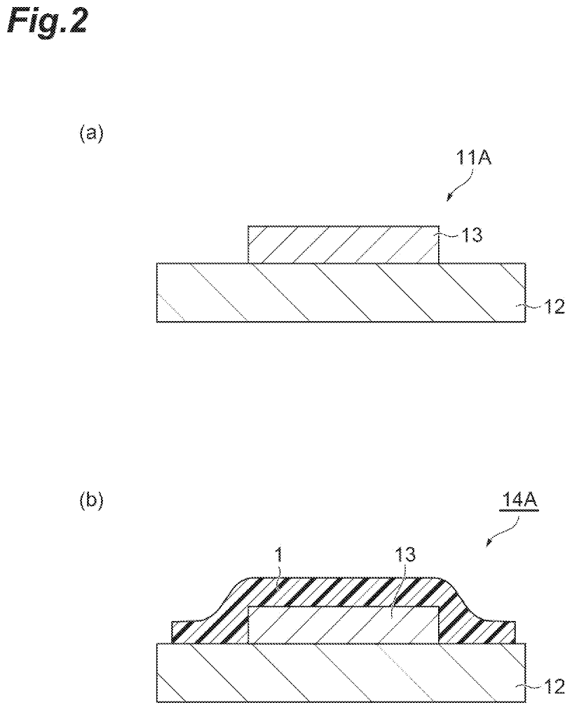

FIG. 2 is a schematic cross-sectional view illustrating an embodiment of an article and a production method therefor. In the method for producing an article of an embodiment, first, as illustrated in FIG. 2(a), an electronic component 11A is prepared as an article that is an object in which the heat storage material is provided. The electronic component 11A contains, for example, a substrate 12 and a semiconductor chip (heat source) 13 provided on the substrate 12.

Subsequently, as illustrated in FIG. 2(b), the sheet-shaped heat storage material 1 is disposed on the substrate 12 and the semiconductor chip 13 so as to be in thermal contact with each of the substrate 12 and the semiconductor chip 13. The heat storage material 1 may be, for example, the aforementioned heat storage material 1A illustrated in FIG. 1(a) and may be the aforementioned heat storage material 1B illustrated in FIG. 1(b). In the case of using the heat storage material 1B illustrated in FIG. 1(b), the heat storage material 1B is disposed so that the adhesive layer 3 is in contact with the substrate 12 and the semiconductor chip 13.

In a case where the heat storage layer in the heat storage material 1 is a cured product obtained by the resin composition being converted into a B stage (semi-cured), the heat storage material 1 is disposed, and then the heat storage layer is cured. That is, the method for producing an article of the present embodiment may further contain a step of curing the heat storage layer of the heat storage material 1 disposed on the substrate 12 and the semiconductor chip 13.

Thereby, an article 14A, which contains the substrate 12, the semiconductor chip 13, and the heat storage material 1 (a cured product of the resin composition) provided on the substrate 12 and the semiconductor chip 13, is obtained.

In the above-described embodiment, the heat storage material 1 is disposed so as to cover the entire exposed surface of the heat source 13, but in another embodiment, the heat storage material may be disposed so as to cover a part of the exposed surface of the heat source.

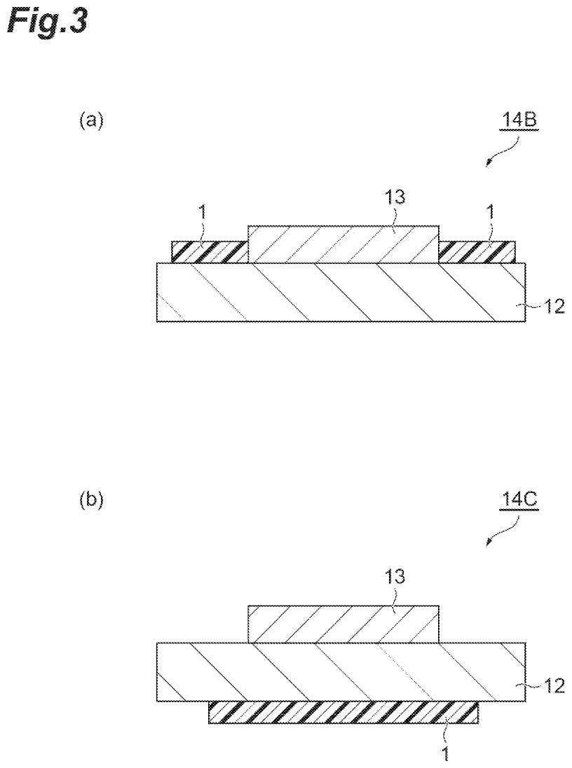

FIG. 3(a) is a schematic cross-sectional view illustrating another embodiment of the article. As illustrated in FIG. 3(a), in an article 14B according to another embodiment, the heat storage material 1 may be disposed, for example, so as to be in contact with a part (so as to cover a part) of the exposed surface of the semiconductor chip (heat source) 13. While a place in which the heat storage material 1 is disposed (a place in which the heat storage material 1 is in contact with the semiconductor chip 13) is a side part of the semiconductor chip 13 in FIG. 3(a), the place may be on any surface of the semiconductor chip 13.

FIG. 3(b) is a schematic cross-sectional view illustrating another embodiment of the article. As illustrated in FIG. 3(b), in an article 14C according to another embodiment, the heat storage material 1 is disposed on the surface of the substrate 12 opposite to the surface on which the semiconductor chip 13 is provided. In the present embodiment, the heat storage material 1 is not in direct contact with the semiconductor chip 13, but is in thermal contact with the semiconductor chip 13 with the substrate 12 therebetween. A place in which the heat storage material 1 is disposed may be on any surface of the substrate 12 as long as it is in thermal contact with the semiconductor chip 13. Also in this case, heat generated in the heat source (the semiconductor chip) 13 is efficiently conducted to the heat storage material 1 with the substrate 12 therebetween, and suitably stored in the heat storage material 1.

In the production method according to the above-described embodiment, the heat storage material 1 has a sheet shape, but in a production method according to another embodiment, an article can also be produced (a heat storage material can also be formed) using a liquid resin composition.

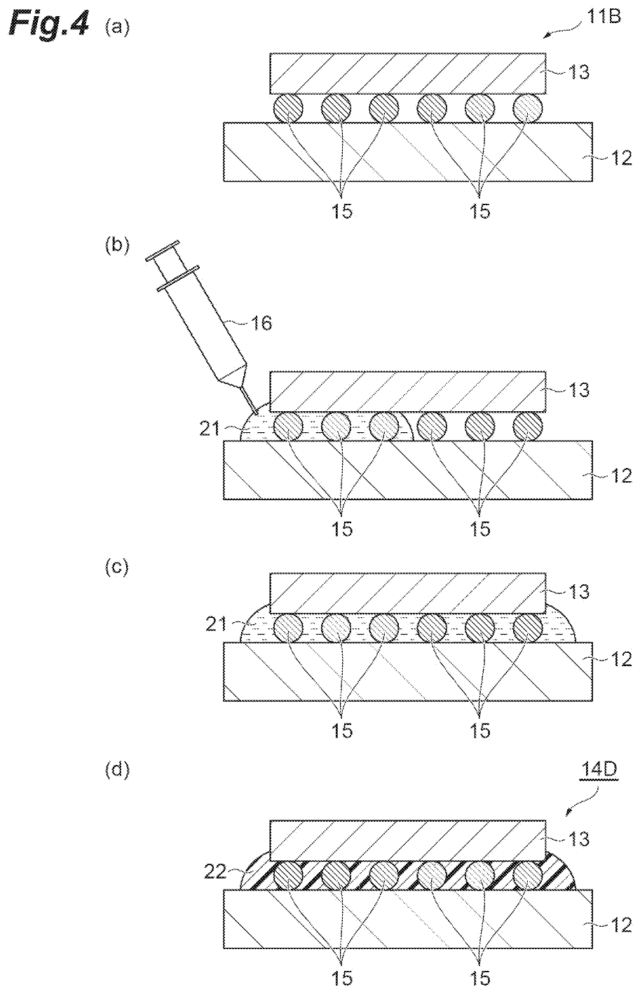

FIG. 4 is a schematic cross-sectional view illustrating another embodiment of the method for producing an article. In the production method according to the present embodiment, first, as illustrated in FIG. 4(a), an electronic component 11B is prepared as an article that is an object in which the heat storage material is provided. The electronic component 11B contains, for example, a substrate (for example, a circuit substrate) 12, a semiconductor chip (heat source) 13 provided on the substrate 12, and a plurality of connecting parts (for example, solders) 15 that connect the semiconductor chip 13 to the substrate 12. The plurality of connecting parts 15 are provided between the substrate 12 and the semiconductor chip 13 so that they are separated from each other. That is, there are gaps between the substrate 12 and the semiconductor chip 13 so that the plurality of connecting parts 15 are separated from each other.

Subsequently, as illustrated in FIG. 4(b), a resin composition 21 is filled between the substrate 12 and the semiconductor chip 13, for example, using a syringe 16. The resin composition 21 is the resin composition according to the aforementioned embodiment. The resin composition 21 may be in a completely uncured state or in a partially cured state.

In a case where the resin composition 21 is in a liquid state at room temperature (for example, 25° C.), the resin composition 21 can be filled at room temperature. In a case where the resin composition 21 has a solid form at room temperature, the resin composition 21 can be heated (for example, at 50° C. or higher) and changed to a liquid state, and then filled.

By filling the resin composition 21 as described above, as illustrated in FIG. 4(c), the resin composition 21 is disposed in the above-described gap between the substrate 12 and the semiconductor chip 13 so as to be in thermal contact with each of the substrate 12, the semiconductor chip 13, and the connecting part 15.

Subsequently, by curing the resin composition 21, as illustrated in FIG. 4(d), a cured product (also referred to as the heat storage layer or the heat storage material) 22 of the resin composition is formed in the above-described gap between the substrate 12 and the semiconductor chip 13. A curing method of the resin composition 21 may be, for example, a method of curing the resin composition 21 by heating the disposed resin composition 21.

In this way, an article 14D, which contains the substrate 12, the semiconductor chip (heat source) 13 provided on the substrate 12, the plurality of connecting parts 15 that connect the semiconductor chip 13 to the substrate 12, and the cured product (the heat storage layer or the heat storage material) 22 of the resin composition that is provided so as to fill between gaps formed by the substrate 12, the semiconductor chip (heat source) 13, and the plurality of connecting parts 15, is obtained.

In the respective embodiments described above, the heat storage material 1 (the cured product 22 of the resin composition) is disposed so as to be in direct contact with the semiconductor chip 13 as a heat source, but the heat storage material and the cured product of the resin composition may be in thermal contact with the heat source, and in another embodiment, for example, the heat storage material may be disposed so as to be in thermal contact with the heat source with a thermally conductive member (such as a heat dissipation member) therebetween.

### EXAMPLES

Hereinafter, the present invention will be further specifically described by means of Examples; however, the present invention is not limited to the following Examples.

[Synthesis of Acrylic Resin]

A 500 mL flask including a stirrer, a thermometer, a nitrogen gas introduction pipe, a discharge pipe, and a heating jacket was used as a reactor, 95 parts by mass of methoxypolyproethylene glycol acrylate (manufactured by NAKAMURA KAGAKUKOGYO CO., LTD., AM-450G, n=45 in the formula (3)) and 5 parts by mass of 2-methacryloyloxyethyl isocyanate as monomers, and 100 parts by mass of ethyl acetate were mixed, the mixture was added to the reactor and stirred at room temperature (25° C.), and nitrogen was caused to flow in the flask for 1 hour. Thereafter, the temperature was raised to 70° C., and after heating was completed, a solution obtained by dissolving 0.28 parts by mass of azobisisobutyronitrile in 2 parts by mass of ethyl acetate was added to the reactor, and the reaction was started. Thereafter, the mixture was stirred at a temperature of 70° C. in the reactor and the reaction continued for 5 hours. Thereafter, a solution obtained by dissolving 0.05 parts by mass of azobisisobutyronitrile in methyl ethyl ketone was added to the reactor, the temperature was raised to 80° C., and additionally the reaction continued for 2 hours. Thereafter, the solvent removal and drying were performed to obtain an acrylic resin. The weight average molecular weight (Mw) of the obtained acrylic resin was 75000.

Furthermore, when the melting point of the obtained acrylic resin was measured as follows, the melting point was 36° C.

Using a differential scanning calorimeter (manufactured by PerkinElmer Co., Ltd., model number DSC8500), the temperature was raised to 100° C. at 20° C./min, the temperature was kept at 100° C. for 3 minutes, the temperature was then lowered to −30° C. at a rate of 10° C./min, the temperature was then kept at −30° C. for 3 minutes, the temperature was then raised to 100° C. again at a rate of 10° C./min, and thus thermal behavior of the acrylic resin was measured, and the melting peak was calculated as a melting point of the acrylic resin.

[Production of Heat Storage Material]

### Example 1

37 parts by mass of acrylic resin, 63 parts by mass of vanadium dioxide (manufactured by Nippon Denko Co., Ltd., VS-40), and 0.2 parts by mass of tertiary amine-based curing accelerator (manufactured by San-Apro Ltd., U-CAT660M) were blended to obtain a resin composition. This resin composition was filled in a mold (SUS plate) having a size of 10 cm×10 cm×1 mm, was covered with an upper lid made of a SUS plate, and then was pressurized at 60 kPa and cured (moisture-cured) at 180° C. for 1.5 hours, thereby obtaining a sheet-shaped heat storage material having a thickness of 1 mm.

### Example 2

A heat storage material was produced by the same method as in Example 1, except that the composition of the resin composition was changed as shown in Table 1.

### Example 3

27.5 parts by mass of acrylic resin, 65.3 parts by mass of vanadium dioxide, 7.2 parts by mass of heat storage capsule (manufactured by Outlast Technology LLC, BA410xxP, C28), 0.2 parts by mass of tertiary amine-based curing accelerator were blended to obtain a resin composition. This resin composition was filled in a mold (SUS plate) having a size of 10 cm×10 cm×1 mm, was covered with an upper lid made of a SUS plate, and then was pressurized at 60 kPa and cured (moisture-cured) at 180° C. for 1.5 hours, thereby obtaining a sheet-shaped heat storage material having a thickness of 1 mm.

### Example 4

A heat storage material was produced by the same method as in Example 3, except that the composition of the resin composition was changed as shown in Table 1.

[Evaluation of Melting Point and Heat Storage Amount]

The heat storage materials produced in Examples were measured using a differential scanning calorimeter (manufactured by PerkinElmer Co., Ltd., model number DSC8500), and the melting point and the heat storage amount were calculated. Specifically, the temperature was raised to 100° C. at 20° C./min, the temperature was kept at 100° C. for 3 minutes, the temperature was then lowered to −30° C. at a rate of 10° C./min, the temperature was then kept at −30° C. for 3 minutes, the temperature was then raised to 100° C. again at a rate of 10° C./min, and thus thermal behavior was measured. The melting peak was used as a melting point of the heat storage material, and the area was used as the heat storage amount. The results are shown in Table 1.

TABLE 1

| | | Example | Example | Example | Example |
|---|---|---|---|---|---|
| | | 1 | 2 | 3 | 4 |
| Composition | Acrylic | 37 | 20 | 27.5 | 12.5 |
| of resin | resin | | | | |
| composition | Vanadium | 63 | 80 | 65.3 | 81.8 |
| (parts by | dioxide | | | | |
| mass) | Heat | — | — | 7.2 | 5.7 |
| | storage | | | | |
| | capsule | | | | |
| | Curing | 0.2 | 0.2 | 0.2 | 0.2 |
| | accelerator | | | | |
| Evaluation | Melting | 43 | 43 | 43 | 43 |
| of heat | point | | | | |
| storage | (° C.) | | | | |
| material | Heat | 159.5 | 177.6 | 164.8 | 165.9 |
| | storage | | | | |
| | amount | | | | |
| | (J/cm³) | | | | |

### REFERENCE SIGNS LIST

1, 1A, 1B: heat storage material, 2: heat storage layer, 3: adhesive layer, 11A, 11B: electronic component, 12: substrate, 13: semiconductor chip (heat source), 14A, 14B, 14C, 14D: article, 15: connecting part, 16: syringe, 21: resin composition, 22: cured product of resin composition (heat storage material).

1. A resin composition comprising:
an acrylic resin polymerized from a monomer component comprising a monomer represented by the following formula (1); and
a heat storage inorganic material, 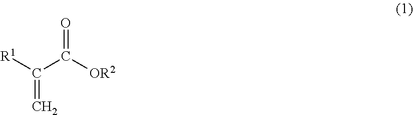
wherein R¹ represents a hydrogen atom or a methyl group, and R² represents a monovalent group having a polyoxyalkylene chain.

2. A resin composition comprising:
an acrylic resin comprising a structural unit represented by the following formula (2); and
a heat storage inorganic material, 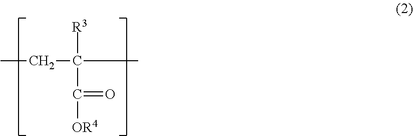
wherein R³ represents hydrogen atom or methyl group, and R⁴ represents a monovalent group having a polyoxyalkylene chain.

3. The resin composition according to claim 1, wherein the monomer component further comprises an additional monomer copolymerizable with the monomer and having a reactive group.

4. The resin composition according to claim 2, wherein the acrylic resin further comprises a structural unit having a reactive group.

5. The resin composition according to claim 3, wherein the reactive group is at least one group selected from the group consisting of a carboxyl group, a hydroxyl group, an isocyanate group, an amino group, and an epoxy group.

6. The resin composition according to claim 3, further comprising a curing agent capable of reacting with the reactive group.

7. The resin composition according to claim 6, wherein the curing agent is at least one curing agent selected from the group consisting of an isocyanate-based curing agent, a phenol-based curing agent, an amine-based curing agent, an imidazole-based curing agent, and an acid anhydride-based curing agent.

8. The resin composition according to claim 1, wherein the heat storage inorganic material comprises vanadium dioxide.

9. The resin composition according to claim 1, further comprising a capsule encapsulating a heat storage organic material.

10. The resin composition according to claim 1, wherein a content of the heat storage inorganic material is 50% by mass or more based on a total amount of the resin composition.

11. (canceled)

12. A heat storage material comprising a cured product of the resin composition according to claim 1.

13. An article comprising:
a heat source; and
a cured product of the resin composition according to claim 1, the cured product in thermal contact with the heat source.

14. The resin composition according to claim 1, wherein the monomer component further comprises an additional monomer represented by the following formula (5): 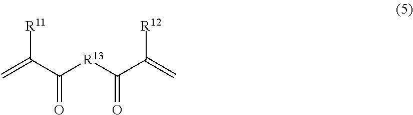
wherein R¹¹ and R¹² each independently represent a hydrogen atom or a methyl group, and R¹³ represents a divalent group having a polyoxyalkylene chain.
